(19) United States
(12) Patent Application Publication
(10) Pub. No.: US 2012/0016842 A1
(43) Pub. Date: Jan. 19, 2012

(54) DATA PROCESSING APPARATUS, DATA PROCESSING METHOD, DATA PROCESSING PROGRAM, AND STORAGE APPARATUS

(75) Inventor: Masanori FURUYA, Kawasaki (JP)

(73) Assignee: FUJITSU LIMITED, Kawasaki-shi (JP)

(21) Appl. No.: 13/110,691

(22) Filed: May 18, 2011

(30) Foreign Application Priority Data
Jul. 14, 2010 (JP) 2010-159433

(51) Int. Cl. G06F 12/16; G06F 17/30

(52) U.S. Cl. 707/649; 707/E17.005

(57) ABSTRACT

In a data processing apparatus, a snapshotting unit creates a second snapshot in a first storage space while a first snapshot of the first storage space exists in a second storage space. A storage unit stores first progress data indicating progress of physical copy to the first storage space for a current second snapshot, and second progress data indicating progress of physical copy to the first storage space for a preceding second snapshot.

### CROSS-REFERENCE TO RELATED APPLICATION

This application is based upon and claims the benefit of priority of the prior Japanese Patent Application No. 2010-159433, filed on Jul. 14, 2010, the entire contents of which are incorporated herein by reference.

### FIELD

The embodiments discussed herein relate to a data processing apparatus, a data processing method, a data processing program, and a storage apparatus.

### BACKGROUND

The operations of a database system include making a backup of data files. Update access to the database is temporarily disabled at regular intervals to back up the files at that moment. Snapshot is known as a technique for such regular backup of database, which instantaneously produces a copy of the dataset frozen at a particular point in time. More specifically, a snapshot is a logical copy of the disk image which is created at a moment and followed by physical copy operation of data. That is, the action of copying a data area happens just before that area is overwritten by a write access. This type of copying method is called “copy-on-write.”

Another known method of snapshot uses both copy-on-write and background copy. That is, the system creates a copy of the entire data image on a background basis, in parallel with copy-on-write operation, after taking a snapshot. This method produces an exact physical duplication of the original data.

To implement the functions discussed above, the snapshot mechanism divides the data image into fixed-size blocks and manages the copy status of each block (i.e., whether the block has been copied). Such copy status information is recorded in the form of, for example, bitmaps.

Snapshots can usually be used as separate datasets independent of the original source dataset. For example, the original data may be used in application A, and its snapshot in application B. It is therefore desirable, from the viewpoint of users, that one snapshot can serve as the source of another snapshot. In this implementation of snapshot, the copy operation performed for the first snapshot has to work in concert with that for the second snapshot. Those two or more coordinated copy operations will be referred to herein as “cascade copy.” (See, for example, Japanese Laid-open Patent Publication No. 2006-244501.)

The cascade copy mechanism ensures the snapshot data under the assumption that a cascade-source snapshot is created before starting a cascade-target snapshot. However, some existing method (e.g., Japanese Laid-open Patent Publication No. 2010-26939) creates a snapshot at the cascade target and then uses its source volume to create another snapshot therein. That is, the cascade-source snapshot is created after the cascade-target snapshot. In this case, it may not be possible to ensure that the resulting snapshot copy can reflect the original source data properly.

### SUMMARY

According to an aspect of the invention, there is provided a data processing apparatus which includes the following elements: a snapshotting unit to create a second snapshot in a first storage space while a first snapshot of the first storage space exists in a second storage space; and a storage unit to store first progress data indicating progress of physical copy to the first storage space for a current second snapshot, and second progress data indicating progress of physical copy to the first storage space for a preceding second snapshot.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an overview of a data processing apparatus according to a first embodiment;

FIG. 2 is a block diagram illustrating a storage system according to a second embodiment;

FIG. 3 is a block diagram illustrating functions of a controller module;

FIG. 4 illustrates a bitmap and a cascade bitmap;

FIGS. 5A and 5B illustrate an example of producing cascade bitmaps;

FIGS. 6A-6C illustrate another example of producing cascade bitmaps;

FIGS. 7A and 7B illustrate yet another example of producing cascade bitmaps;

FIGS. 8A and 8B illustrate still another example of producing cascade bitmaps;

FIG. 9 illustrates a configuration of volumes for the purpose of explanation of a proposed control method;

FIG. 10 is a flowchart of a data write operation;

FIG. 11 is a flowchart of a data read operation;

FIG. 12 illustrates a specific example of a control method using cascade bitmaps;

FIGS. 13A-13D illustrate, for comparison purposes, a specific example of a control method which does not use cascade bitmaps;

FIG. 14 illustrates another specific example of a control method using cascade bitmaps;

FIG. 15 illustrates yet another specific example of a control method using cascade bitmaps;

FIG. 16 illustrates still another specific example of a control method using cascade bitmaps; and

FIGS. 17A and 17B illustrate an application of the processing method according to the second embodiment.

### DESCRIPTION OF EMBODIMENTS

Embodiments of the present invention will be described below with reference to the accompanying drawings, wherein like reference numerals refer to like elements throughout. The following description begins with an overview of a data processing apparatus according to a first embodiment and then proceeds to more specific embodiments.

### (A) FIRST EMBODIMENT

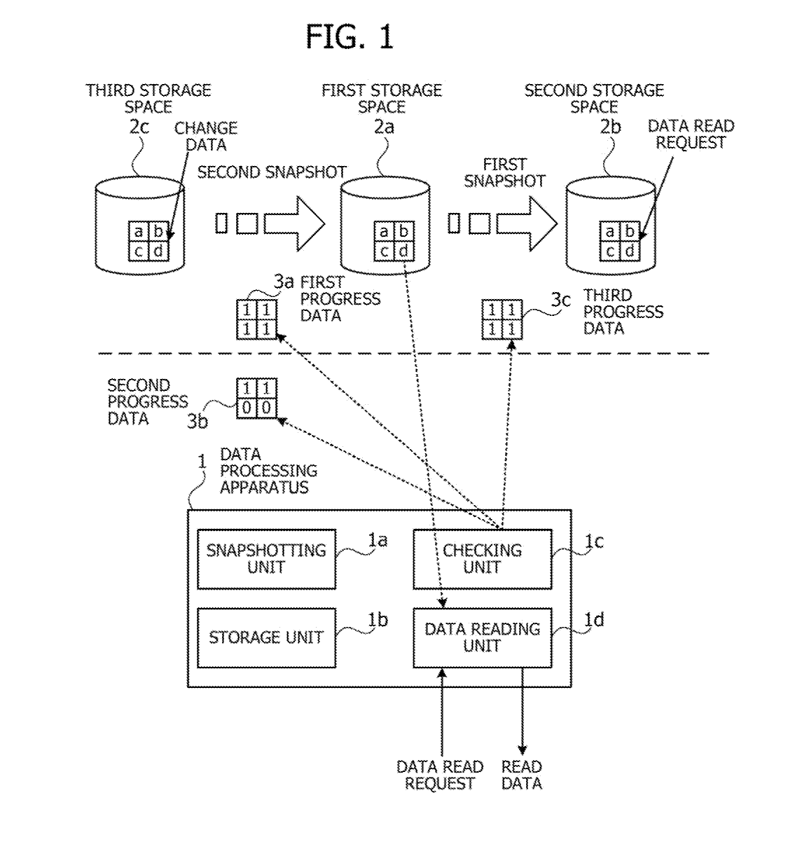

FIG. 1 illustrates an overview of a data processing apparatus according to a first embodiment. The illustrated data processing apparatus 1 according to the first embodiment includes a snapshotting unit 1a and a storage unit 1b.

The snapshotting unit 1a creates a second snapshot in a first storage space 2a, while a first snapshot of the first storage space 2a exists in a second storage space 2b. Referring to the example of FIG. 1, a third storage space 2c has blocks “a,” “b,” “c,” and “d” to store data. The first storage space 2a also has blocks “a,” “b,” “c,” and “d” similarly. The snapshotting unit 1a creates a second snapshot of data stored in those four blocks of the third storage space 2c, in the corresponding blocks of the first storage space 2a. The first storage space 2a, second storage space 2b, and third storage space 2c may be implemented on, for example, hard disk drives (HDD) or solid state drives (SSD). The first storage space 2a, second storage space 2b, and third storage space 2c may physically be located in separate storage devices, or may be concentrated in a single device.

Snapshot makes a logical copy of the disk image at a moment. Physical copy of each data area (or block) of the snapshot is performed just before a data access is made to that block. The progress of this physical copy operation is recorded on an individual block basis. The resulting records of physical copy are referred to herein as “progress data.” The functions of creating and updating such progress data may be implemented in, for example, the snapshotting unit 1a.

The storage unit 1b stores progress data for current and previous snapshots, i.e., the latest two second snapshots created successively. More specifically, first progress data 3a indicates the progress of physical copy to the first storage space 2a which is performed for the latest second snapshot. Second progress data 3b indicates the progress of physical copy to the first storage space 2a which is performed for the previous second snapshot. For example, FIG. 1 illustrates at least two instances of the second snapshot from the third storage space 2c to the first storage space 2a. According to the present embodiment, the first progress data 3a and second progress data 3b are stored in bitmap form. Specifically, the first progress data 3a has four bit cells corresponding to the four blocks “a,” “b,” “c,” and “d” of the third storage space 2c and first storage space 2a. Similarly the second progress data 3b has four bit cells corresponding to the four blocks “a,” “b,” “c,” and “d” in the third storage space 2c and first storage space 2a.

Each bit of the first progress data 3a and second progress data 3b contains either “0” or “1.” The value of “0” in a bit cell indicates that the corresponding block has undergone physical copy processing to the first storage space 2a (i.e., the original data has been copied). The value of “1” in a bit cell indicates that the corresponding block has not yet undergone physical copy processing to the first storage space 2a (i.e., the original data has not yet been copied). All bits of the first progress data 3a are set to “1” as their initial values at the start of creating a new second snapshot. As seen in FIG. 1, the first progress data 3a maintains the value of “1” in every bit corresponding to the blocks “a,” “b,” “c,” and “d.” This means that none of those four blocks has undergone physical copy processing from the third storage space 2c to the first storage space 2a since the current second snapshot was taken. The second progress data, on the other hand, contains “1” in bit cells corresponding to blocks “a” and “b,” and “0” in bit cells corresponding to blocks “c” and “d.” This indicates that two blocks “c” and “d” have already undergone physical copy processing from the third storage space 2c to the first storage space 2a since the previous second snapshot was taken.

Similar to the progress data of second snapshots discussed above, the storage unit 1b also stores third progress data 3c indicating the progress of physical copy from the first storage space 2a to the second storage space 2b for the current first snapshot. The first snapshot illustrated in FIG. 1, however, has no progress data in the position corresponding to the second progress data 3b of the second snapshot. This lack of progress data means that the snapshotting unit 1a has so far produced only one first snapshot. While not illustrated in FIG. 1, additional progress data for first snapshots may be created similarly to the second progress data. When this is the case, each bit of the progress data is to be populated with a value of “1.”

According to the first embodiment, the data processing apparatus 1 may include a checking unit 1c and a data reading unit 1d. The checking unit 1c is responsive to a data read request directed to a block in the second storage space 2b. In response to such a request, the checking unit 1c checks the second progress data 3b to determine whether the specified block of the previous second snapshot have undergone physical copy processing from the third storage space 2c to the first storage space 2a. The present embodiment assumes here that there is a data read request to block “d” in the second storage space 2b.

The data reading unit 1d handles data read requests from other devices (not illustrated) outside the data processing apparatus 1 to the first storage space 2a, second storage space 2b, and third storage space 2c. When there is a data read request to block “d” in the second storage space 2b, the checking unit 1c consults the first progress data 3a, second progress data 3b, and third progress data 3c to determine whether the block “d” has already undergone physical copy processing for respective snapshots.

More specifically, the checking unit 1c is supposed to identify where the requested data is actually stored. To this end, the checking unit 1c first tests a bit in the third progress data 3c which corresponds to the specified block “d.” This corresponding bit (referred to herein as “block-d bit”) in the third progress data 3c has a value of “1” to indicate that block “d” has not been copied. Accordingly, the data reading unit 1d determines that the requested data does not reside in the second storage space 2b.

To determine the actual location of the requested data, the checking unit 1c now consults the first progress data 3a and second progress data 3b, which describe snapshots taken from the third storage space 2c to the first storage space 2a. The block-d bit in the first progress data 3a, on the other hand, has a value of “1” to indicate that block “d” has not been copied to the first storage space 2a. On the other hand, the block-d bit in the second progress data 3b has a value of “0” to indicate that block “d” has already been copied to the first storage space 2a. This means that physical copy of block “d” is completed in the second snapshot. The checking unit 1c thus concludes that the requested data of block “d” resides in the first storage space 2a. The checking unit 1c then notifies the data reading unit 1d of this determination result. Based on the notification from the checking unit 1c, the data reading unit 1d reads data from block “d” in the first storage space 2a and sends the read data to the requesting device outside the data processing apparatus 1.

It is noted that both the first progress data 3a and third progress data 3c indicate a value of “1” in their bits corresponding to block “d,” meaning that block “d” has not undergone a physical copy operation. If the checking unit 1c was designed to consult only first progress data 3a and third progress data 3c in determining whether block “d” has been copied, the checking unit 1c would have determined that the requested data still resides in the third storage space 2c, thus causing the data reading unit 1d to read data from block “d” of the third storage space 2c. The first progress data 3a, however, has actually been initialized at the start of re-creating a new second snapshot, and thus every bit has a value of “1.” For this reason, the current first progress data 3a can no longer provide correct information as to which blocks have been copied since the previous second snapshot was created. For example, the third storage space 2c has actually been changed in its block “d” since the previous second snapshot was created, as indicated by the left solid arrow in FIG. 1. The first progress data 3a, however, contains a value of “1” in its block-d bit, thus failing to indicate that change made to the original data. With the first progress data 3a being reset to 1s, the checking unit 1c concludes that the requested data resides in the first storage space 2a. Accordingly the data reading unit 1d reads out, not the desired original data, but the changed data.

According to the present embodiment, the proposed data processing apparatus 1 stores second progress data 3b separately from the first progress data 3a, so that the progress of physical copy to the first storage space 2a for the preceding second snapshot can be checked even after a new second snapshot is created. While data in the third storage space 2c may be changed after the preceding second snapshot is made, the second progress data 3b prevents the data reading unit 1d from reading out data from an unintended place.

The above-described snapshotting unit 1a may be implemented as a function of a central processing unit (CPU) of the data processing apparatus 1. The above-described storage unit 1b may be implemented as part of the data storage space of Random access memory (RAM), hard disk drive, or the like in the data processing apparatus 1. The following sections will describe a more specific embodiment.

### (B) SECOND EMBODIMENT

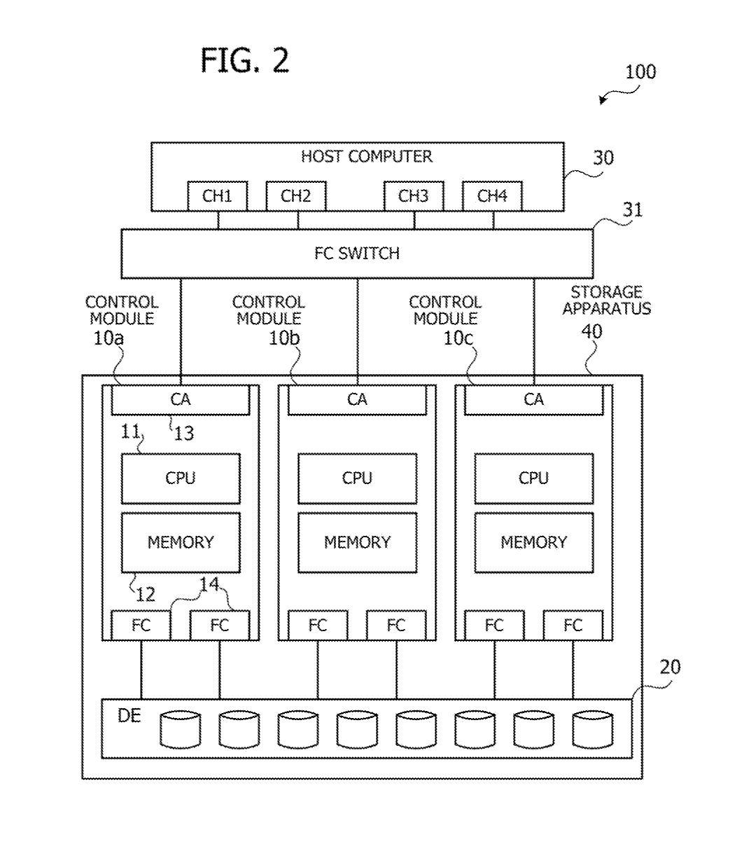

FIG. 2 is a block diagram illustrating a storage system according to a second embodiment. The illustrated storage system 100 includes, among others, a host computer 30 and a storage apparatus 40.

The storage apparatus 40 includes a plurality of controller modules (CM) 10a, 10b, and 10c and a drive enclosure (DE) 20. The controller modules 10a, 10b, and 10c can individually be attached to or detached from the storage apparatus 40.

The controller modules 10a, 10b, and 10c are identical in their functions and equally capable of writing data to and reading data from the drive enclosure in the storage apparatus 40. The illustrated storage system 100 has redundancy in its hardware configuration to increase reliability of operation. That is, the storage system 100 has two or more controller modules.

The controller module 10a includes a CPU 11 to control the module in its entirety. Coupled to the CPU 11 via an internal bus are a memory 12, a channel adapter (CA) 13, and Fibre Channel (FC) interfaces 14. The memory temporarily stores the whole or part of software programs that the CPU 11 executes. The memory 12 is also used to store various data objects to be manipulated by the CPU 11. The memory 12 further store copy bitmaps and cascade bitmaps as will be described later.

The channel adapter 13 is linked to a Fibre Channel switch 31. Via this Fibre Channel switch 31, the channel adapter 13 is further linked to channels CH1, CH2, CH3, and CH4 of the host computer 30, allowing the host computer 30 to exchange data with the CPU 11. FC interfaces 14 are connected to the external drive enclosure 20. The CPU 11 exchanges data with the drive enclosure 20 via those FC interfaces 14.

The above-described hardware configuration of the controller module 10a is also applied to other controller modules 10b and 10c. Each controller module 10a, 10b, and 10c sends an I/O command (access command data) to the drive enclosure 20 to initiate a data input and output operation on a specific storage space of the storage apparatus 40. The controller modules 10a, 10b, and 10c then wait for a response from the drive enclosure 20, counting the time elapsed since their I/O command. In the event that a specific access monitoring time expires, the controller modules 10a, 10b, and 10c send an abort request command to the drive enclosure 20 to abort the requested I/O operation.

The drive enclosure 20 accommodates a plurality of volumes which may be specified as the source and destination of cascade copy. A volume is formed from, for example, hard disk drives, SSD, magneto-optical discs, and optical discs (e.g., Blu-ray discs). The drive enclosure may be configured to provide a RAID array with data redundancy.

While FIG. 2 illustrates only one host computer 30, the present embodiment permits two or more such host computers to have access to the storage apparatus 40. The processing functions of controller modules 10a, 10b and 10c can be implemented on the above-described hardware platform. The next section will describe more about the functions that the controller module 10a offers.

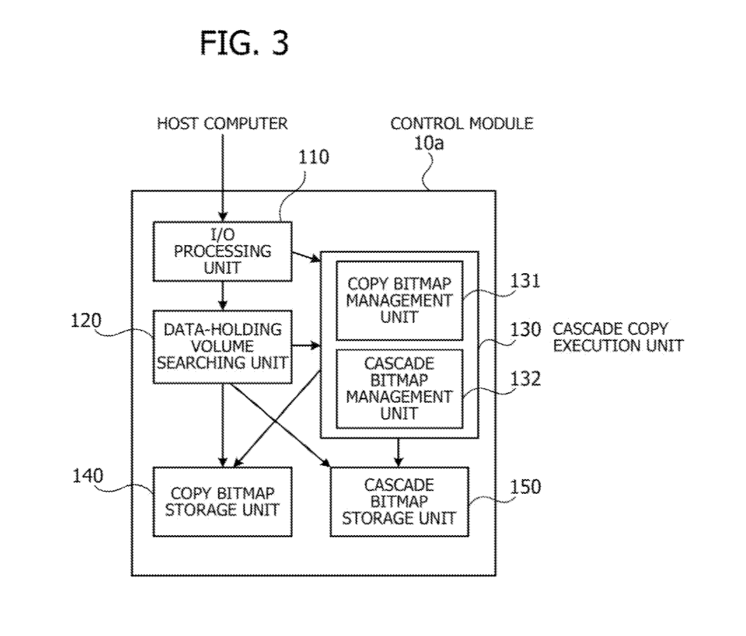

FIG. 3 is a block diagram illustrating functions of a controller module. The illustrated controller module 10a includes, among others, an I/O processing unit 110 which serves as an interface with the host computer 30 by executing input and output operations. Specifically, when a data read request for a specific block of a specific volume is received from the host computer 30, the I/O processing unit 110 reads data out of the specified block of the specified volume in the drive enclosure 20 and sends the read data back to the requesting host computer 30. When, on the other hand, a data write request for a specific block of a specific volume is received from the host computer 30, the I/O processing unit 110 writes given data in the specified block of the specified volume in the drive enclosure 20. The host computer 30 may also issue a command that requests creation of a snapshot. Upon receipt of such a command, the I/O processing unit 110 forwards the command to a cascade copy execution unit 130 (described below) and returns a response to the host computer 30 when the command is executed.

The controller module 10a also includes a data-holding volume searching unit 120 and a cascade copy execution unit 130. The data-holding volume searching unit 120 is responsive to a data write request and a data read request received by the I/O processing unit 110. Specifically, the data-holding volume searching unit 120 determines in which volume the data specified in the received data write or read request is stored. More specifically, the I/O processing unit 110 examines each relevant copy bitmap to determine whether the physical copy of data from a source volume to a target volume has been finished. The data-holding volume searching unit 120 also searches each volume for crucial data as will be described later.

The cascade copy execution unit 130 provides snapshot functions. The cascade copy execution unit 130 also executes cascade copy, i.e., the coordinated copy operations initiated by two successive snapshots.

The cascade copy execution unit 130 includes a copy bitmap management unit 131 and a cascade bitmap management unit 132. The copy bitmap management unit 131 produces a copy bitmap when a snapshot is created. The copy bitmap management unit 131 also updates this copy bitmap when cascade copy is executed. The cascade bitmap management unit 132 produces a cascade copy bitmap when a snapshot is created. The cascade bitmap management unit 132 also updates this cascade copy bitmap when cascade copy is executed.

The controller module 10a further includes a copy bitmap storage unit 140 to store the copy bitmaps and a cascade bitmap storage unit 150 to store the cascade bitmaps. The next section will describe what is indicated by those bitmaps and cascade bitmaps.

### (C) BITMAPS AND CASCADE BITMAPS

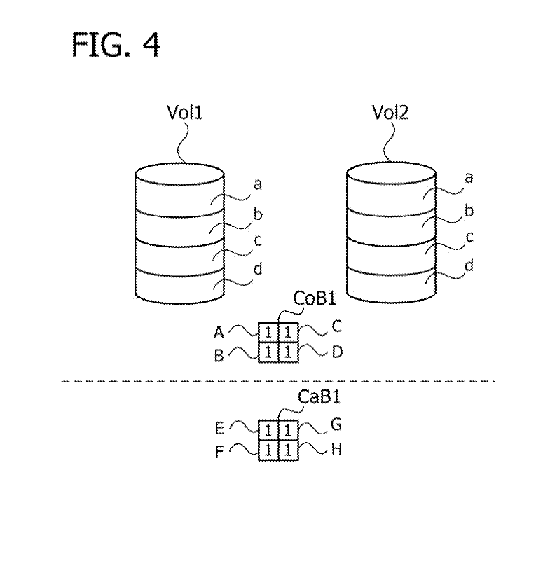

FIG. 4 illustrates a bitmap and a cascade bitmap. For explanatory purposes, the volumes Vol1 and Vol2 in the present embodiment are each divided into four storage spaces, i.e., blocks “a” to “d.” As described in the preceding section, the copy bitmap management unit 131 produces a copy bitmap when a snapshot is created. The produced copy bitmap CoB1 has four bitmap cells A to D corresponding to blocks “a” to “d,” respectively. The copy bitmap management unit 131 gives “0” to those bitmap cells A to D to indicate that their corresponding blocks “a” to “d” have undergone physical copy processing, or “1” to indicate that their corresponding blocks “a” to “d” have not yet undergone physical copy processing. For example, the copy bitmap management unit 131 populates bitmap cell A in copy bitmap CoB1 with a value of “0” when physical copy is done from block “a” of volume Vol1 to block “a” of volume Vol2, subsequent to creation of a snapshot from volume Vol1 to volume Vol2. This zero-valued bitmap cell A in the copy bitmap CoB1 indicates completion of physical copy from block “a” of volume Vol1 to block “a” of volume Vol2.

The cascade bitmap management unit 132 produces a cascade copy bitmap when a snapshot is created, as well as when cascade copy is executed. For example, the produced cascade bitmap CaB1 has four bitmap cells E to H corresponding to blocks “a” to “d.” Further, bitmap cell E corresponds to bitmap cell A. Bitmap cell F corresponds to bitmap cell B. Bitmap cell G corresponds to bitmap cell C. Bitmap cell H corresponds to bitmap cell D.

The cascade bitmap management unit 132 gives “0” to those bitmap cells E to H when their corresponding blocks “a” to “d” have undergone physical copy processing. The cascade bitmap management unit 132 gives “1” to those bitmap cells E to H when their corresponding blocks “a” to “d” have not yet undergone physical copy processing. For example, the cascade bitmap management unit 132 populates bitmap cell E in the copy bitmap CaB1 with a value of “0” when physical copy is done from block “a” of volume Vol1 to block “a” of volume Vol2, subsequent to re-creation of a snapshot from volume Vol1 to volume Vol2. This zero-valued bitmap cell E in the copy bitmap CaB1 indicates completion of physical copy from block “a” of volume Vol1 to block “a” of volume Vol2.

The rest of this description will use the symbols “A” to “H” to refer to individual bitmap cells while subsequent drawings omit the same. The next section will now describe how cascade bitmaps are produced.

### (D) METHOF OF PRODUCING CASCADE BITMAPS

For example, the cascade bitmap management unit 132 produces cascade bit maps according to the following four rules:

(i) Rule 1

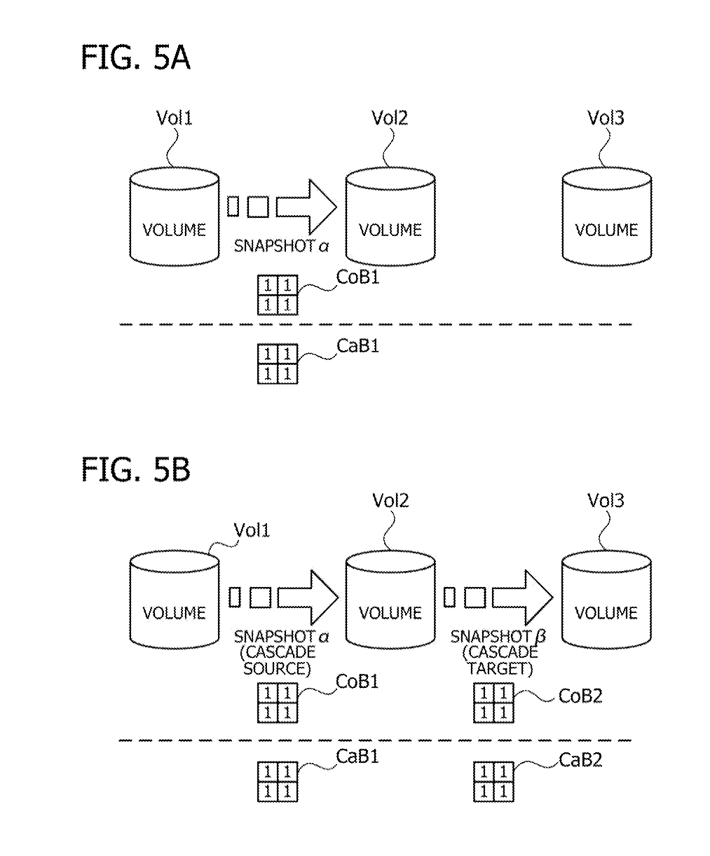

FIGS. 5A and 5B illustrate an example of producing cascade bitmaps. According to the present embodiment, the cascade bitmap management unit 132 provides a cascade bitmap with all bits set to “1” to indicate that physical copy processing, when newly starting a single snapshot or cascade copy processing.

Specifically, FIG. 5A illustrates snapshot α of volume Vol1 which is created in volume Vol2. When starting to make a new snapshot α of volume Vol1 in volume Vol2, the cascade bitmap management unit 132 produces cascade bitmap CaB1 whose bitmap cells E to H are populated with “1.” Also the copy bitmap management unit 131 produces copy bitmap CoB1 whose bitmap cells A to D are populated with “1.” Now that snapshot α is newly created, copy bitmap CoB1 will be updated, as necessary, with new values of bitmap cells A to D according to the progress of physical copy processing. Cascade bitmap CaB1 is different from copy bitmap CoB1 in that its bitmap cells E to H maintain their initial values (=1) until the next round of snapshot α is performed.

FIG. 5B illustrates snapshot β of volume Vol2 which is created in volume Vol3. The symbols “α” and “β” are used to distinguish two snapshots from each other, but it is noted that they do not imply any particular order of snapshots. The physical copy for snapshot α of volume Vol1 is performed together with the physical copy for snapshot β of volume Vol2. Those two operations thus constitute cascade copy. In the following description, the physical copy for snapshot α will be referred to as “cascade source copy,” and the physical copy for snapshot β as “cascade target copy.”

When starting to make a new snapshot β of volume Vol2 in volume Vol3, the copy bitmap management unit 131 produces copy bitmap CoB2 with all bitmap cells A to D set to “1”. Also, the cascade bitmap management unit 132 creates cascade bitmap CaB2 with all bitmap cells E to H set to “1.”

As can be seen from the above, the controller module 10a according to the present embodiment is configured to produce a cascade bitmap and a copy bitmap at the time of creating snapshot α and snapshot β. The embodiment is, however, not limited by this specific example, but may be modified to create a cascade bitmap at the time of executing cascade copy processing, rather than at the time of creating a snapshot.

(ii) Rule 2

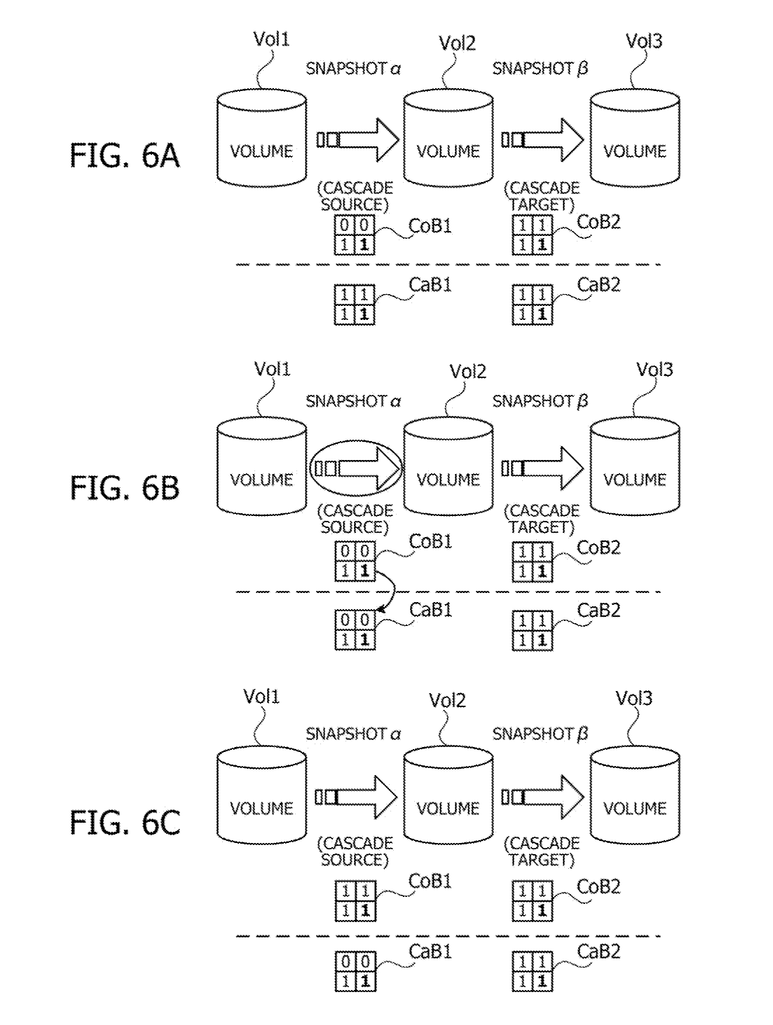

FIGS. 6A-6C illustrate another example of producing cascade bitmaps. Specifically, FIG. 6A illustrates a situation where cascade copy is under way. More specifically, the cascade copy execution unit 130 executes snapshot α, and a logical copy of the data image is thus created in volume Vol2 instantaneously. This snapshotting is followed by physical copy processing of blocks “a” and “b” from volume Vol1 to volume Vol2.

FIGS. 6B and 6C illustrate a situation where the cascade copy execution unit 130 re-creates a cascade source copy (i.e., snapshot α from volume Vol1 to volume Vol2) from scratch while cascade copy in volumes Vol1 to Vol3 is under way. This re-creation of a cascade source copy by the cascade copy execution unit 130 causes the cascade bitmap management unit 132 to calculate a logical product (AND) of the data stored in bitmap cells A to D of copy bitmap CoB1 and its counterpart in bitmap cells E to H of cascade bitmap CaB1. The result of this logical product operation is stored in cascade bitmap CaB1 as illustrated in FIG. 6B. Cascade bitmap CaB1 is partly overwritten with a portion of copy bitmap CoB1 to reflect the status of blocks that have undergone physical copy processing for snapshot α.

Afterwards the copy bitmap management unit 131 updates copy bitmap CoB1 as can be seen in FIG. 6C. For example, the re-creation of snapshots causes the copy bitmap CoB1 to be ready for physical copy of all blocks “a” to “d” form volume Vol1 to volume Vol2. Accordingly, the copy bitmap management unit 131 changes all bitmap cells A to D of copy bitmap CoB1 to “1” to indicate that their physical copy is pending.

As can be seen from the above, Rule 2 makes the cascade bitmap management unit 132 save copy bitmap CoB1 by overwriting cascade bitmap CaB1 when snapshot α is re-created. This feature ensures reliable data read operation from the drive enclosure 20 in the case of re-creation of snapshot α.

(iii) Rule 3

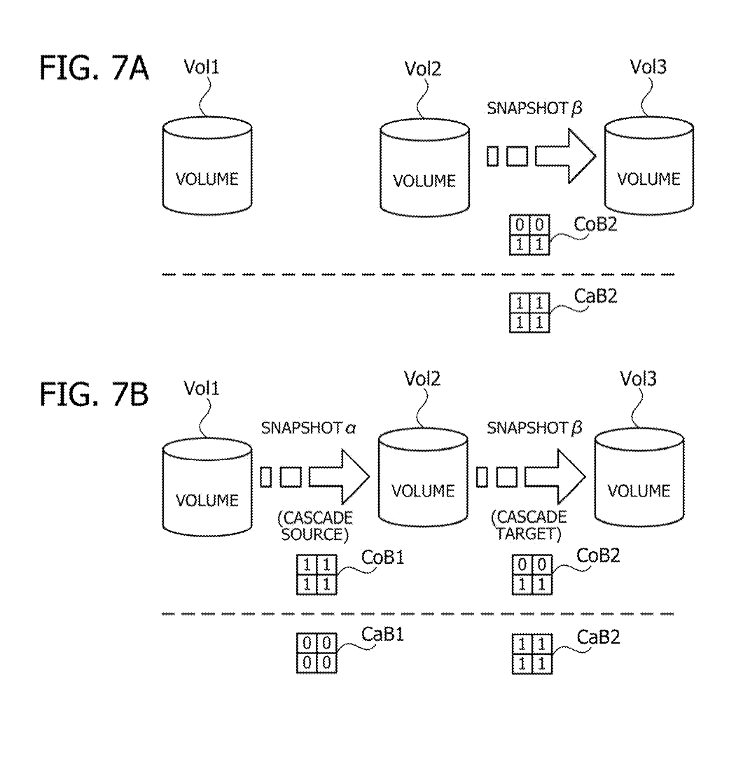

FIGS. 7A and 7B illustrate yet another example of producing cascade bitmaps. Specifically, FIG. 7A illustrates snapshot β from volume Vol2 to volume Vol3. Suppose now that another snapshot α is started from volume Vol1 to volume Vol2 after snapshot β is made from volume Vol2 to volume Vol3. In this case, the two snapshot α and β are regarded as cascade source and cascade target snapshots, respectively.

The cascade bitmap management unit 132 creates a cascade bitmap CaB1 when starting snapshot α for the first time. As can be seen in FIG. 7B, every bit of this cascade bitmap CaB1 is set to “0,” which indicates that all blocks have undergone physical copy processing. The cascade bitmap management unit 132, on the other hand, sets every bit of copy bitmap CoB1 to “1,” thus indicating that no blocks have undergone physical copy processing, so that the cascade copy execution unit 130 is ready to copy all blocks “a” to “d” from volume Vol1 to volume Vol2 for the sake of snapshot α.

As can be seen from the above, the cascade bitmap management unit 132 gives “0” to every bit of cascade bitmap CaB1 when starting snapshot α for the first time. Those zero-valued bits of cascade bitmap CaB1 indicate that the data contained in volume Vol2 can be used as is when there is a data read request or a data write request. This feature ensures that correct data can be read out of the drive enclosure 20 even in the case where cascade source snapshot α is created later than cascade target snapshot.

(iv) Rule 4

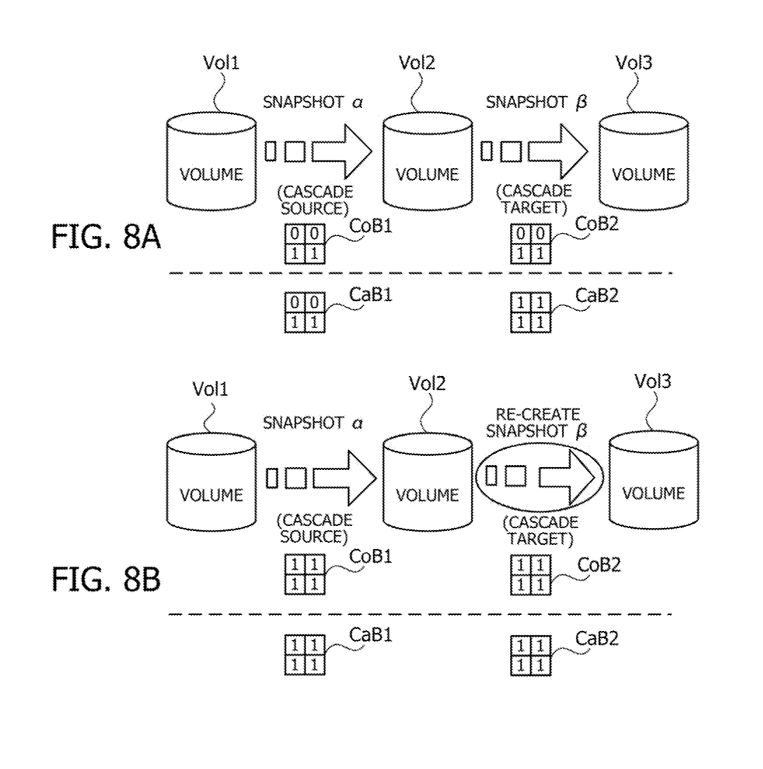

FIGS. 8A and 8B illustrate still another example of producing cascade bitmaps. Specifically, FIG. 8A illustrates a situation where cascade copy is in progress with volumes Vol1 to Vol3. FIG. 8B illustrates how the copy bitmaps and cascade bitmaps are manipulated when a snapshot is re-created in volume Vol2 and volume Vol3.

It is assumed here that copy processing from volume Vol1 to volume Vol2 is under way at the cascade source. In this situation, the cascade copy execution unit 130 may re-create a snapshot from volume Vol2 to volume Vol3 at the cascade target. When this happens, the cascade bitmap management unit 132 sets every bit of cascade bitmap CaB1 at the target source to “1” to indicate that no blocks have been copied. The cascade bitmap management unit 132 acts in this way since the cascade copy execution unit 130 can manage the copies by using copy bitmaps CoB1 and CoB2 only in the case where cascade copy is executed first in the cascade source and then in the cascade target.

The next section will describe, with reference to some flowcharts, how the storage apparatus 40 uses cascade bitmaps when there is a data write request or a data read request from the host computer 30.

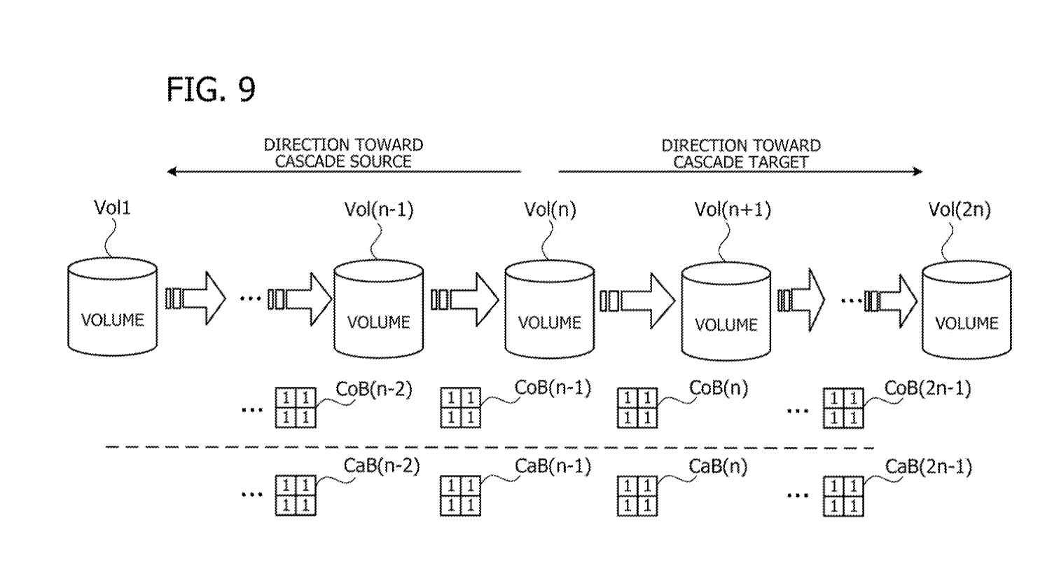

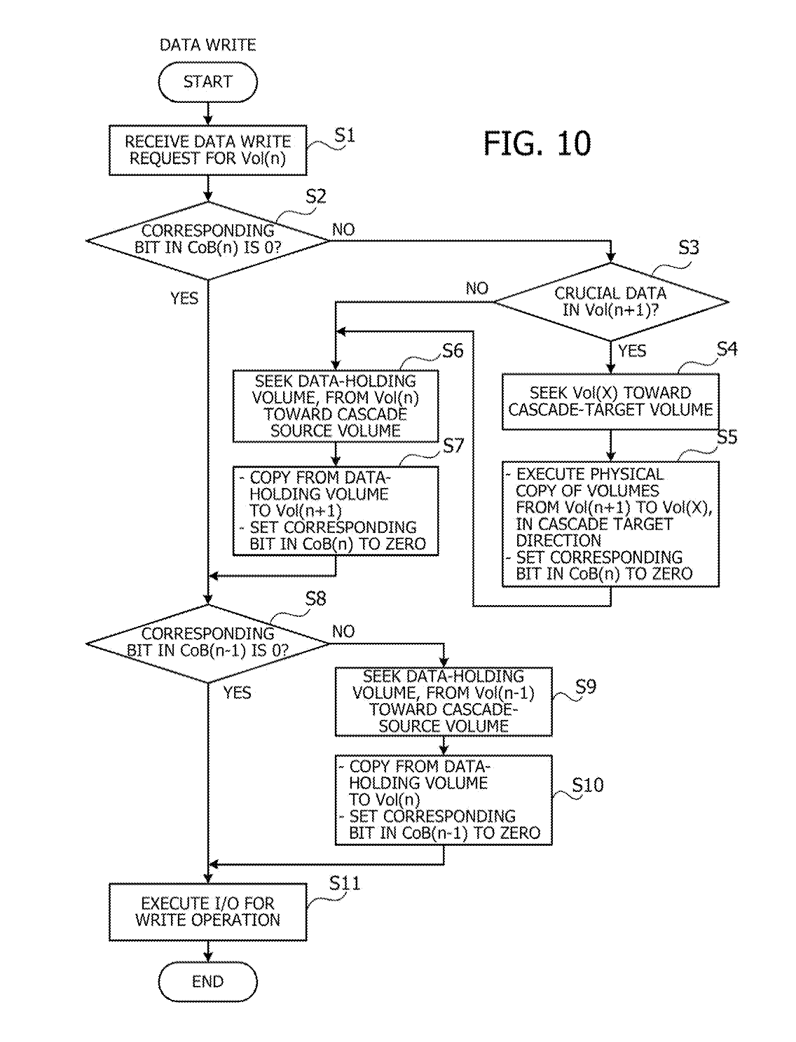

FIG. 9 illustrates a configuration of volumes for the purpose of explanation of a proposed control method. The flowchart of FIG. 10 assumes that volumes are arranged in the way illustrated in FIG. 9. Specifically, the drives installed in the drive enclosure 20 according to the present embodiment are divided into (2n+1) volumes as illustrated in FIG. 9. When viewed from volume Vol(n) in FIG. 9, the direction toward volume Vol1 is referred to as “cascade source” direction, and the direction toward volume Vol(2n) is referred to as “cascade target” direction. The volumes aligning in these two directions are respectively referred to as the cascade source side and cascade target side.

FIG. 10 is a flowchart illustrating a data write operation. Each processing step of this flowchart will now be described below in the order of step numbers.

(Step S1) The I/O processing unit 110 receives a data write request directed to volume Vol(n), which permits the process to advance to step S2.

(Step S2) The data-holding volume searching unit 120 examines copy bitmap CoB(n−1) to find a bit corresponding to the block specified by the data write request to volume Vol(n). This bit is referred to herein as a “corresponding bit.” The data-holding volume searching unit 120 determines whether the corresponding bit of copy bitmap CoB(n−1) has a value of “0.” If the correspondence bit is “0” (Yes at step S2), the data-holding volume searching unit 120 determines that the specified block of volume Vol(n) has undergone physical copy processing. The process then proceeds to step S8. If the correspondence bit is not “0” (No at step S2), the data-holding volume searching unit 120 determines that the specified block of volume Vol(n) has not yet undergone physical copy processing. The process thus proceeds to step S3.

(Step S3) The data-holding volume searching unit 120 determines whether the volume Vol(n+1) contains any “crucial data.” More specifically, data in volume Vol(n+1) is determined to be “crucial” when both the following two conditions are true: (a) the corresponding bit of cascade bitmap CaB(n) that describes cascade copy from volume Vol(n) to volume Vol(n+1) is set to “0” (i.e., indicating completion of physical copy processing), and (b) the corresponding bit of a copy bitmap that describes copy from volume Vol(n+1) is set to “1” (i.e., indicating no physical copy processing).

When no crucial data is found in volume Vol(n+1) (No at step S3), the process skips to step S6. When there is crucial data in volume Vol(n+1) (Yes at step S3), the process advances to step S4.

(Step S4) The data-holding volume searching unit 120 seeks a volume Vol(X) that has no crucial data, by tracing the series of volumes from Vol(n+1) in the cascade target direction. If such a volume Vol(X) is found, the process advances to step S5. If no such volume Vol(X) is found, the data-holding volume searching unit 120 selects the endmost volume Vol(2n) as volume Vol(X).

(Step S5) The data-holding volume searching unit 120 executes physical copy of volumes sequentially in the cascade target direction, from volume Vol(n+1) up to volume Vol(X). Suppose, for example, that Vol(n+3) is found to be volume Vol(X). In this case, the data-holding volume searching unit 120 first executes physical copy from volume Vol(n+1) to volume Vol(n+2), and then from volume Vol(n+2) to volume Vol(n+3). After that, the data-holding volume searching unit 120 gives “0” to the corresponding bit of copy bitmap CoB(n) describing the snapshot from volume Vol(n) to volume Vol(n+1), thereby indicating that the physical copy has been finished. The process then advances to step S6.

(Step S6) The data-holding volume searching unit 120 seeks a data-holding volume by tracing the series of volumes from volume Vol(n) in the cascade source direction. More specifically, when the corresponding bit in a copy bitmap or a cascade bitmap on the cascade source side is “0” (i.e., indicates completion of physical copy processing), the data-holding volume searching unit 120 identifies the copy target volume of that bitmap as a data-holding volume. For example, volume Vol(n) is identified as a data-holding volume in the case where the corresponding bit of cascade bitmap CaB(n−1) has a value of “0.” When the above operation of tracing back to the cascade source volume finds no session indicating completion of physical copy of the specified access area, the data-holding volume searching unit 120 selects volume Vol1, the topmost of all cascaded volumes, as a data-holding volume. Now that the data-holding volume is determined, the process advances to step S7.

(Step S7) The cascade copy execution unit 130 executes physical copy from the data-holding volume determined at step S6 to volume Vol(n+1). Upon completion of this physical copy from the data-holding volume to volume Vol(n+1), the copy bitmap management unit 131 sets the corresponding bit of copy bitmap CoB(n) to “0,” thus indicating the completion.

(Step S8) The data-holding volume searching unit 120 examines the corresponding bit of copy bitmap CoB(n−1) for physical copy from volume Vol(n−1) to volume Vol(n). When the corresponding bit is “0” (Yes at step S8), the data-holding volume searching unit 120 determines that volume Vol(n) has undergone physical copy of the block specified in the data write request. The process advances to step S11 accordingly. When, on the other hand, the corresponding bit is not “0” (No at step S8), the data-holding volume searching unit 120 determines volume Vol(n) has not undergone a physical copy operation of the block specified in the data write request. The process thus advances to step S9.

(Step S9) The data-holding volume searching unit 120 seeks a data-holding volume by tracing the series of volumes from volume Vol(n−1) in the cascade source direction. More specifically, when the corresponding bit in a copy bitmap or a cascade bitmap on the cascade source side is “0” (i.e., indicates completion of physical copy), the data-holding volume searching unit 120 identifies the copy target volume corresponding to that bitmap as a data-holding volume. When the above tracing in the cascade source direction finds no session indicating completion of physical copy of the specified access area, the data-holding volume searching unit 120 selects volume Vol1, the topmost of all cascaded volumes, as a data-holding volume. The process then advances to step S10.

(Step S10) The cascade copy execution unit 130 executes physical copy from the data-holding volume determined at step S9 to volume Vol(n). The copy bitmap management unit 131 then sets the corresponding bit of copy bitmap CoB(n−1) to “0” to indicate completion of the physical copy. The process then advances to step S11.

(Step S11) The I/O processing unit 110 accepts the data write I/O operation and returns a response to the host computer 30. This concludes the data write operation.

The process illustrated in FIG. 10 has been explained. The next section will describe a data read operation.

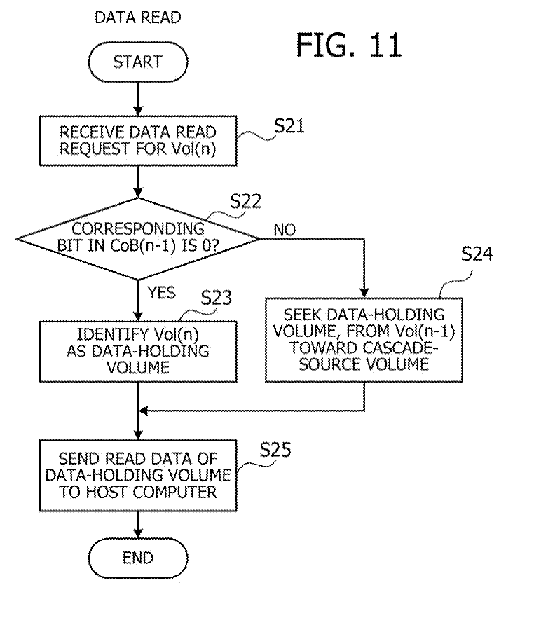

FIG. 11 is a flowchart of a data read operation. Each processing step of this flowchart will now be described below in the order of step numbers.

(Step S21) The I/O processing unit 110 receives a data read request directed to Vol(n), which causes the process to advance to step S22.

(Step S22) The data-holding volume searching unit 120 examines the corresponding bit of copy bitmap CoB(n−1) describing physical copy from volume Vol(n−1) to volume Vol(n). When the correspondence bit is “0” (Yes at step S22), the data-holding volume searching unit 120 determines that the specified block of volume Vol(n) has undergone physical copy processing. The process then advances to step S23. When, on the other hand, the correspondence bit is not “0” (No at step S22), the data-holding volume searching unit 120 determines that the specified block of volume Vol(n) has not yet undergone physical copy processing. The process then proceeds to step S24.

(Step S23) The data-holding volume searching unit 120 identifies volume Vol(n) as a data-holding volume. The process then advances to step S25.

(Step S24) The data-holding volume searching unit 120 seeks a data-holding volume by tracing the series of volumes from volume Vol(n) in the cascade source direction. More specifically, when the corresponding bit in a copy bitmap or a cascade bitmap has a value of “0” (i.e., indicates completion of physical copy), the data-holding volume searching unit 120 identifies the copy target volume corresponding to that bitmap as a data-holding volume. When the above operation of tracing back to the cascade source volume finds no session indicating completion of physical copy of the specified access area, the data-holding volume searching unit 120 selects volume Vol1, the topmost of all cascaded volumes, as a data-holding volume. The process then advances to step S25.

(Step S25) The I/O processing unit 110 reads data from the data-holding volume that the data-holding volume searching unit 120 has determined at step S23 or S24 and sends the read data back to the host computer 30 as a response to the data read request. This response may be made in any appropriate way since the data read operation does not necessitate physical copy processing. That is, there is no particular limitation as to the method of returning a response. Step S25 concludes the data read operation.

The processing operation of FIG. 11 has been described. The next section provides several examples of control using cascade bitmaps. Specifically, the following specific examples 1 to 4 relate to the above-described flowcharts.

### (E) SPECIFIC EXAMPLES

### (i) Example 1

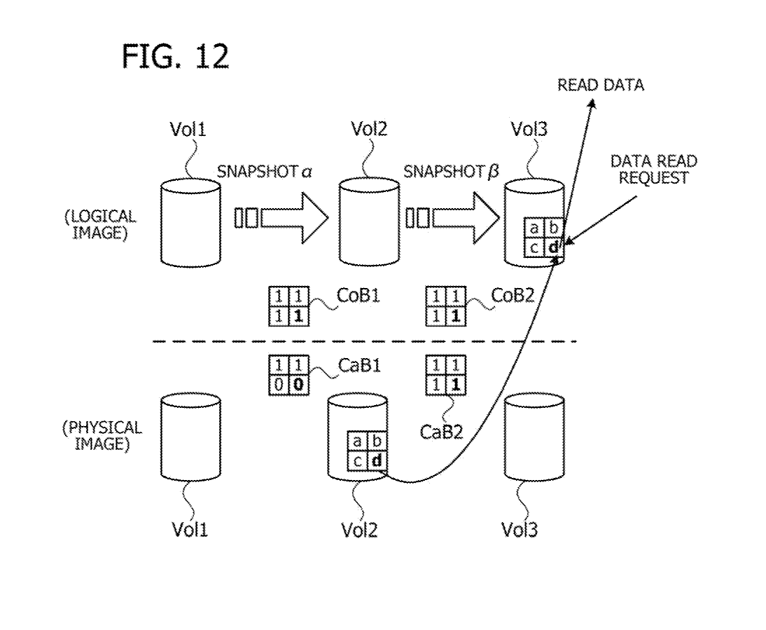

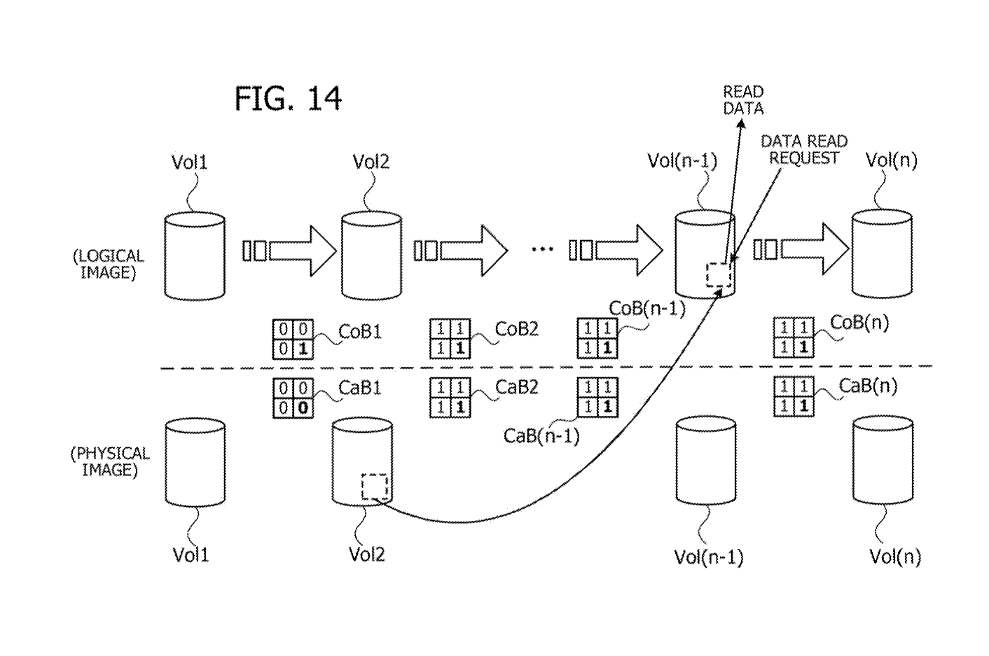

FIG. 12 illustrates a specific example of a control method using cascade bitmaps. This example 1 illustrates how a data read request to snapshot β is handled when there are two snapshots β and α created in that order. Specifically, FIG. 12 depicts both logical and physical images produced by the execution of snapshot of a volume. Each pair of logical and physical images are identified by the same volume name. This notation also applies to FIGS. 14, 15, and 16.

When the I/O processing unit 110 receives from the host computer 30 a data read request to block “d” of volume Vol3, the data-holding volume searching unit 120 looks into copy bitmaps CoB1 and CoB2, as well as cascade bitmaps CaB1 and CaB2, of each snapshot and examines their corresponding bit representing block “d.” As can be seen from FIG. 12, cascade bitmap CaB1 of snapshot α contains a value of “0” in its bitmap cell H corresponding to block “d,” which indicates that physical copy of the block “d” has been finished. This enables the data-holding volume searching unit 120 to determine that the specified block “d” was copied from volume Vol1 to volume Vol2 before re-creation of the current snapshot α. Accordingly, the I/O processing unit 110 responds to the host computer 30 by providing physical data read out of block “d” of volume Vol2.

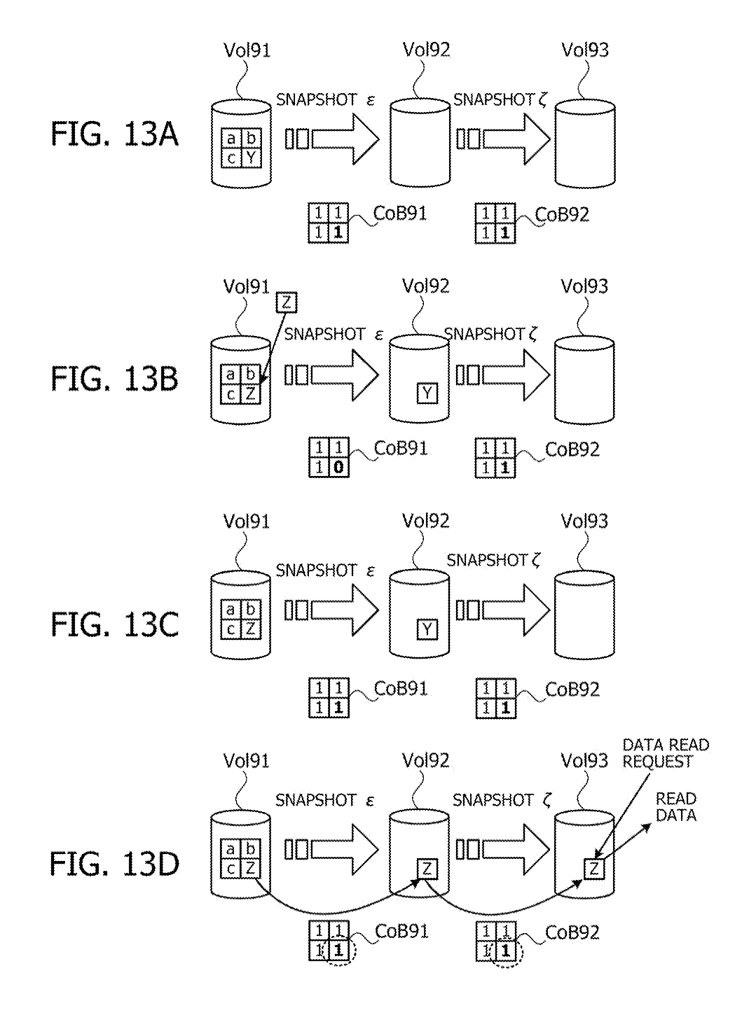

FIGS. 13A-13D illustrate, for comparison purposes, a specific example of a control method which does not use cascade bitmaps. Specifically, FIG. 13A illustrates a situation where copy bitmaps CoB91 and CoB92 are created as a result of snapshot ε and snapshot ζ, with every bit set to “1” to indicate that physical copy of blocks has not been done. Sometime later, data Y in block “d” is copied from volume Vol91 to volume Vol92 upon write operation of data Z as depicted in FIG. 13B. When this physical copy is done, the corresponding bit of copy bitmap CoB91 is set to “0” to indicate that block “d” has undergone physical copy processing.

The data values of volume Vol93 are actually related to two snapshots ε and ζ. When a data request to block “d” of this volume Vol93 is received, the read operation has to take place at the right place, i.e., volume Vol92, that contains the original data values Y of block “d” at the moment of creating snapshot ζ. As illustrated in FIG. 13B, the data values of block “d” was changed from Y to Z after its physical copy from volume Vol91 to volume Vol92 is done. The cascade-source snapshot ε is then re-created as seen in FIG. 13C, which resets every bit of copy bitmap CoB91 to “1” in accordance with the foregoing rule 2. The corresponding bit in both copy bitmaps CoB91 and CoB92 indicates that block “d” has not yet been copied, meaning that the physical data of block “d” resides in volume Vol91. For this reason, the changed data values Z are read out of volume Vol91, as depicted in FIG. 13D, in response to the data request to block “d.”

In contrast, the foregoing specific example 1 demonstrates that the proposed control method ensures the reliability of snapshot data. This benefit is achieved by providing cascade bitmap CaB1 to save the value of each bitmap cell of copy bitmap CoB1 when re-creating a snapshot.

### (ii) Specific Example 2

FIG. 14 illustrates another specific example of a control method using cascade bitmaps. This specific example 2 illustrates how data is read out of an intermediate volume in the case of multi-stage cascade copy. Here the term “multi-stage cascade copy” refers to the configuration where a plurality of stages of cascade copy are concatenated.

As illustrated in FIG. 14, the I/O processing unit 110 receives from the host computer 30 a data read request to block “d” of volume Vol(n−1). In response, the data-holding volume searching unit 120 seeks a data-holding volume by tracing the cascaded volumes from the specified Vol(n−1) toward the cascade source volume (i.e., Vol(n−2), Vol(n−3), and so on). Actually the data-holding volume searching unit 120 examines copy bitmaps and cascade bitmaps of those volumes. When the corresponding bit in a copy bitmap or a cascade bitmap has a value of “0” (i.e., indicates completion of physical copy), the data-holding volume searching unit 120 identifies the copy target volume corresponding to that bitmap as a data-holding volume.

In the example of FIG. 14, the corresponding bit in cascade bitmap CaB1 indicates that the specified block “d” has been copied. This means that the requested data physically resides in volume Vol2. The data-holding volume searching unit 120 thus determines this volume Vol2 to be the data-holding volume.

The I/O processing unit 110 responds to the host computer 30 by providing physical data read out of volume Vol2. To minimize the processing load of copy operation, the controller module 10a may be configured to store this physical data in volume Vol(n−1) before it is sent to the host computer 30 in response to the data read request. In this case, the send data may be read out of volume Vol(n−1).

### (iii) Specific Example 3

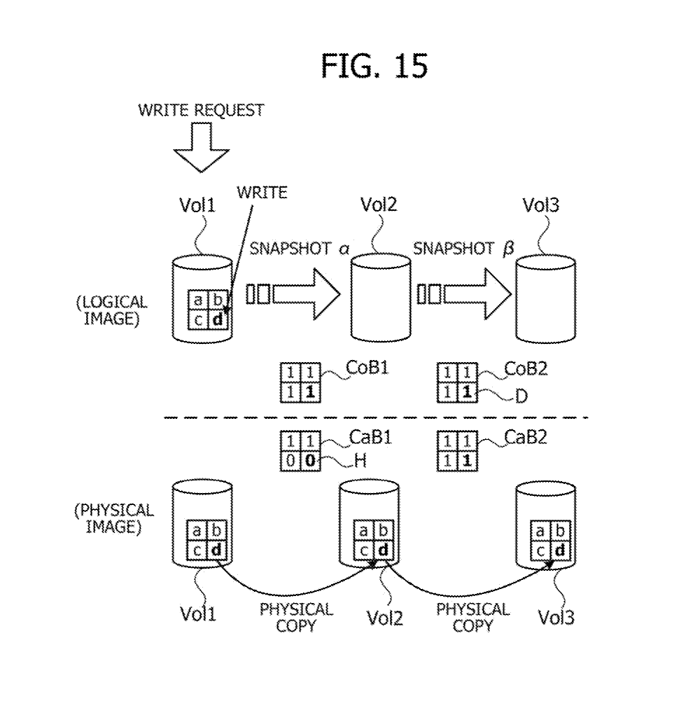

FIG. 15 illustrates yet another specific example of a control method using cascade bitmaps. This example 3 illustrates how a data write request to volume Vol1 is handled when there are two snapshots β and α created in that order.

Suppose that the I/O processing unit 110 receives a data write request to block “d” of volume Vol1 from the host computer 30. As can be seen from FIG. 15, cascade bitmap CaB1 has a value of “0” in its bitmap cell H, indicating that block “d” of the volume of snapshot α has undergone physical copy processing. As can also be seen from FIG. 15, copy bitmap CoB2 has a value of “1” in its bitmap cell D, indicating that block “d” of the volume of snapshot β has not yet been copied. This situation means that volume Vol2 contains the original data of block “d” before snapshot α is re-created, and that volume Vol3 needs that original data. Accordingly, the data-holding volume searching unit 120 determines that volume Vol2 contains crucial data.

Since volume Vol2 contains crucial data, the cascade copy execution unit 130 executes physical copy of this crucial data from volume Vol2 to volume Vol3 before starting physical copy of block “d” from volume Vol1 to volume Vol2. The I/O processing unit 110 is now allowed to write new data values into block “d” of volume Vol1 according to the received data write request.

### (iv) Specific Example 4

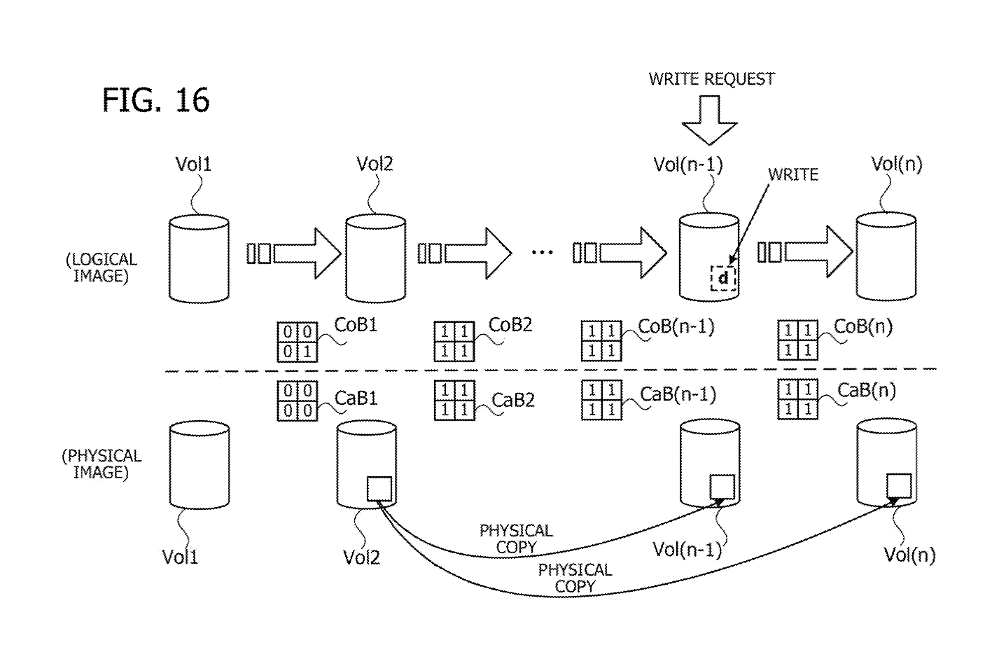

FIG. 16 illustrates still another specific example of a control method using cascade bitmaps. This example 4 illustrates how a data write request to an intermediate volume is handled in the case of multi-stage cascade volumes.

Suppose that the I/O processing unit 110 receives from the host computer 30 a data write request to block “d” of volume Vol(n−1) as illustrated in FIG. 16. In response, the data-holding volume searching unit 120 looks into copy bitmap CoB(n) of the snapshot from volume Vol(n−1) to volume Vol(n). All bits of copy bitmap CoB(n−1) in this specific example 4 are set to “1” to indicate that no blocks have been copied. Accordingly, the data-holding volume searching unit 120 starts to seek a data-holding volume, by tracing the series of volumes from volume Vol(n) in the cascade source direction.

In the example of FIG. 16, the corresponding bit of cascade bitmap CaB1 has a value of “0,” which indicates that the block has undergone physical copy processing. Accordingly, the data-holding volume searching unit 120 identifies volume Vol2 as the data-holding volume. The cascade copy execution unit 130 thus executes physical copy from volume Vol2 to volume Vol(n−1), as well as from volume Vol2 to volume Vol(n).

In the case where the data-holding volume of volume Vol(n) precedes volume Vol(n−1), it logically means that volume Vol(n−1) and volume Vol(n) share the same data-holding volume. When this is the case, the data-holding volume searching unit 120 may skip the second search for a data-holding volume.

As can be seen from the above description, the storage system 100 according to the embodiment can create a new snapshot from the copy target data of snapshot β, whether the physical copy for preceding snapshot α has been finished or not. The proposed storage system 100 can also create a snapshot in the copy source volume of snapshot α, whether the physical copy for snapshot β has been finished or not.

Further, the embodiment enables re-creation of any one of the snapshots that constitute a cascade. The proposed method thus ensures the reliability of produced snapshot data.

### (F) APPLICATIONS

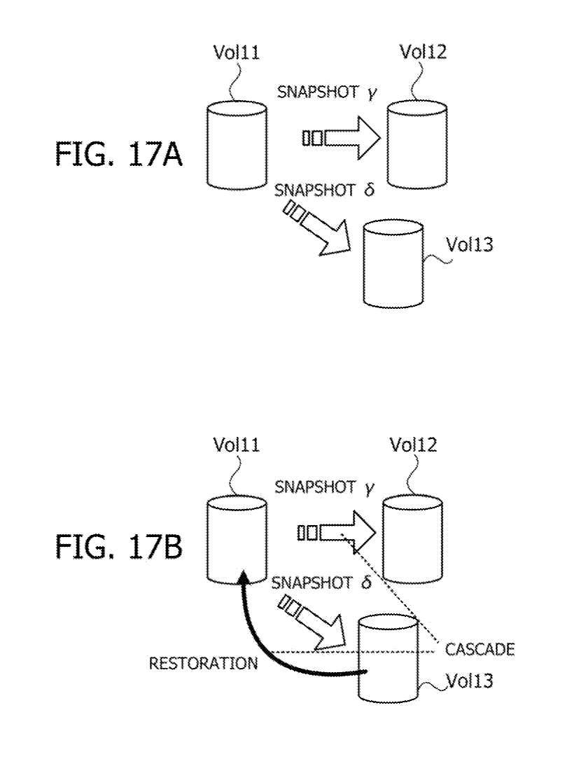

FIGS. 17A and 17B illustrate an application of the processing method according to the second embodiment. Specifically, FIGS. 17A and 17B illustrate snapshot γ from volume Vol11 to volume Vol12, as well as snapshot δ from volume Vol11 to volume Vol13. That is, a plurality of snapshots are created from the same source volume. It may be desired in this case to restore one of those snapshots back to the source volume. One such example is when a snapshot is taken as a backup of data in the source volume. In the event of data disruption, the source volume can be restored by using the stored snapshot. The mechanism of instantaneous snapshot may also be applied to the restoration process. This is advantageous in terms of the time required for data restoration.

It is noted that the newly started restoration process and the existing snapshot γ constitute a cascade. Thus the foregoing rules 1 to 4 are similarly applied to the restoration process. That is, the restoration process uses copy bitmaps and cascade bitmaps that have been created and updated, thus ensuring the reliability of restored data.

The above-described processing functions may be implemented on a computer system. To achieve this implementation, the instructions describing the functions of the data processing apparatus 1 and controller modules 10a, 10b, and 10c are encoded and provided in the form of computer programs. A computer system executes those programs to provide the processing functions discussed in the preceding sections. The programs may be stored in a computer-readable, non-transitory medium. Such computer-readable media include magnetic storage devices, optical discs, magneto-optical storage media, semiconductor memory devices, and other tangible storage media. Magnetic storage devices include hard disk drives (HDD), flexible disks (FD), and magnetic tapes, for example. Optical disc media include DVD, DVD-RAM, CD-ROM, CD-RW and others. Magneto-optical storage media include magneto-optical discs (MO), for example.

Portable storage media, such as DVD and CD-ROM, are used for distribution of program products. Network-based distribution of software programs may also be possible, in which case several master program files are made available on a server computer for downloading to other computers via a network.

A computer stores necessary software components in its local storage unit, which have previously been installed from a portable storage medium or downloaded from a server computer. The computer executes programs read out of the local storage unit, thereby performing the programmed functions. Where appropriate, the computer may execute program codes read out of a portable storage medium, without installing them in its local storage device. Another alternative method is that the computer dynamically downloads programs from a server computer when they are demanded and executes them upon delivery.

The processing functions discussed in the preceding sections may also be implemented wholly or partly by using a digital signal processor (DSP), application-specific integrated circuit (ASIC), programmable logic device (PLD), or other electronic circuit.

Various embodiments have been discussed above. As can be seen from those embodiments, the proposed techniques ensure the reliability of snapshot data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A data processing apparatus comprising:
a snapshotting unit to create a second snapshot in a first storage space while a first snapshot of the first storage space exists in a second storage space; and
a storage unit to store first progress data indicating progress of physical copy to the first storage space for a current second snapshot, and second progress data indicating progress of physical copy to the first storage space for a preceding second snapshot.

2. The data processing apparatus according to claim 1, further comprising:
a checking unit, responsive to a data read request to a specific block in the second storage space, to determine, based on the second progress data, which blocks of the previous second snapshot have undergone physical copy processing from a third storage space to the first storage space; and
a data reading unit to read data out of the first storage space in response to the data read request, when the checking unit has determined that the specific block has undergone physical copy processing to the first storage space for the preceding second snapshot.

3. The data processing apparatus according to claim 1, wherein:
the storage unit further holds third progress data indicating progress of physical copy to the second storage space for the first snapshot;
the second snapshot is a snapshot of a third storage space;
the snapshotting unit is also responsive to a data write request to a specific block of the third storage space; and
when the second progress data indicates that the specific block specified in the data write request has undergone physical copy processing, and when the third progress data indicates that the requested block has not yet undergone physical copy processing, the snapshotting unit copies the specific block from the first storage space to the second storage space and subsequently copies the specific block from the third storage space to the first storage space.

4. The data processing apparatus according to claim 1, wherein the snapshotting unit overwrites the second progress data with the first progress data and then resets the first progress data so as to indicate that no blocks have undergone physical copy processing, when re-creating a new second snapshot.

5. The data processing apparatus according to claim 1, wherein the snapshotting unit changes the second progress data so as to indicate that blocks have undergone physical copy processing, when starting creation of the second snapshot for the first time.

6. The data processing apparatus according to claim 1, wherein the snapshotting unit resets the second progress data so as to indicate that no blocks have undergone physical copy processing when re-creating a new first snapshot while physical copy processing to the first storage space for the current second snapshot is not finished.

7. The data processing apparatus according to claim 1, wherein the first progress data and the second progress data are stored in bitmap form.

8. A data processing method comprising:
creating a second snapshot in a first storage space while a first snapshot of the first storage space exists in a second storage space; and
storing first progress data indicating progress of physical copy to the first storage space for a current second snapshot, and second progress data indicating progress of physical copy to the first storage space for a preceding second snapshot.

9. A non-transitory computer-readable medium storing a data processing program which causes a computer to execute a procedure comprising:
creating a second snapshot in the first storage space while a first snapshot of the first storage space exists in the second storage space; and
storing first progress data indicating progress of physical copy to the first storage space for a current second snapshot, and second progress data indicating progress of physical copy to the first storage space for a preceding second snapshot.

10. A storage apparatus comprising:
a storage device having a first storage space and a second storage space;
a snapshotting unit to create a second snapshot in the first storage space while a first snapshot of the first storage space exists in the second storage space; and
a storage unit to store first progress data indicating progress of physical copy to the first storage space for a current second snapshot, and second progress data indicating progress of physical copy to the first storage space for a preceding second snapshot.
